(19) United States
(12) Patent Application Publication
(10) Pub. No.: US 2012/0174831 A1
(43) Pub. Date: Jul. 12, 2012

(54) ADDITIVE FOR MINERAL BINDING AGENTS

(75) Inventors: Colin Hurley, Buckinghamshire (GB); Jorg M. Schrabback, Muhlhausen (DE); Thomas Heller, Nussloch (DE); Dieter Honert, Dielheim (DE)

(73) Assignee: SIKA TECHNOLOGY AG, Baar (CH)

(21) Appl. No.: 13/497,197

(22) PCT Filed: Sep. 21, 2010
(86) PCT No.: PCT/EP10/63903

§ 371 Date: Mar. 26, 2012

(30) Foreign Application Priority Data
Sep. 21, 2009 (EP) 09170837.0
Sep. 21, 2009 (EP) 09170854.5

(51) Int. Cl. C04B 16/00; C08K 3/00

(52) U.S. Cl. 106/808; 106/809; 524/2; 524/3; 524/5

(57) ABSTRACT

An additive composition comprising at least one lignosulfonate is used for reducing the amount of soot floating on mineral binding agents. Methods for reducing the amount of soot floating on mineral binding agents where an additive composition comprising at least one lignosulfonate is added to a mineral binding agent.

### TECHNICAL AREA

The invention relates to the area of additives in grinding and blending processes of hydraulic binding agents and/or latent hydraulic binding agents.

### PRIOR ART

Cement production is very energy-intensive and causes large carbon dioxide emissions. Using ashes such as for example fly ash, silica fume or rice husk ashes as additives in the production of mineral binding agents can save cement, which is advantageous both from the viewpoint of energy consumption and environmental protection. These ashes have however the disadvantage that they contain soot which can float on mineral binding agents, in particular on aqueous hydraulically set binding agents, and which in turn can lead to unseemly surfaces and damage, for example due to the loss of adhesion of coats applied to such surfaces.

A crucial step in cement production is grinding the cement clinker. Since cement clinkers are very hard, crushing them is very energy-intensive. However, it is important for the properties of cement to get cement in the form of fine powder. The fineness of cement is therefore an important quality criterion. In order to make crushing into powder easier, so-called cement grinding agents are used. This greatly reduces the grinding times and energy costs.

Some cement grinding agents have the disadvantage that they have diluting properties for hydraulic binding agents after a certain amount, for example deflocculation causes solid particles to become distributed individually and become more mobile, leading to a lowering of the liquid limit, i.e. to a reduction in viscosity. This favors in particular the floating of soot and thereby exasperates the problem.

### DESCRIPTION OF THE INVENTION

The purpose of the present invention was therefore to provide new additives for the grinding and blending process of hydraulic binding agents and/or latent hydraulic binding agents which do not have the mentioned disadvantages of the prior art but instead have good suspension-stabilizing properties preventing in particular soot from floating up.

The term “floating” refers in this document to the accumulation of soot on the surface of mineral binding agents due to separation processes. This concerns both aqueous mineral binding agents and mineral binding agents that are essentially water-free.

Surprisingly it was now found that it is possible to use an additive composition Z comprising at least one lignosulfonate to reduce the floating of soot on mineral binding agents containing said soot compared to mineral binding agents containing said soot but not an additive composition Z.

Furthermore it was surprisingly found that by combining the additive composition Z comprising at least one lignosulfonate with the usual cement grinding agents the disadvantages of the known grinding agents can be eliminated and/or at least much reduced without losing the advantageous effects of the usual cement grinding agents.

Surprisingly it also was shown that the addition of additive composition Z does not have any negative effects on the efficiency of the grinding process.

And finally it was surprisingly found that the addition of additive composition Z does not have any negative effect on the compressive strength of the set mineral binding agent.

### METHODS FOR IMPLEMENTING THE INVENTION

The present invention relates to the use of an additive composition Z comprising at least one lignosulfonate to reduce the floating of soot on the mineral binding agents containing said soot.

The mineral binding agents are hydraulic binding agents and/or latent hydraulic binding agents and/or pozzolanic binding agents. The term hydraulic binding agent refers in this document to binding agents that set or harden also under water, such as for example hydraulic lime or cement. The term latent hydraulic binding agents in this document refers to binding agents that set or harden only under the influence of additives (activators), such as for example finely ground granulated slag. The term pozzolanic binding agent refers in this document to binding agents that do not set by themselves but yield solidifying reaction products after damp storage by binding calcium hydroxide, such as for example fly ash, silica fume and natural pozzolans such as e.g. trass.

The hydraulic binding agents and/or latent hydraulic binding agents and/or pozzolanic binding agents are typically selected from the group consisting of cement, fly ashes, silica fume, trass, rice husk ashes and finely ground granulated slag, or blends thereof.

Preferably at least one further component of the mineral binding agent is selected from the group consisting of fly ash, silica fume, finely ground granulated slag, trass and rice husk ashes.

Fly ash, silica fume, finely ground granulated slag, trass and rice husk ashes are used in particular as so-called main components in cement and contain unburned residual carbon, soot, which can float on a mineral binding agent, in particular an aqueous mineral binding agent. This creates unseemly surfaces and damage, for example through the loss of adhesion of coats applied to such surfaces. The floating of soot on an aqueous mineral binding agent, for example concrete, can lead in particular to stippling and soot nests on the surface. These are unseemly and can lead to the release of soot into the environment due to dust formation. Since soot is typically an undesirable by-product of combustion with a large amount of polycyclical aromatic hydrocarbons that are injurious to health, this is a further disadvantage.

Fly ashes are a combustion residue from coal-fired power plants. The fine-grained combustion residues of coal dust are extracted from the flue gas in the power station using electrostatic filters (filter dust). Fly ash can be used in cement production both as a raw material component and main ingredient of cement and as a concrete additive. According to DIN EN 196-2, the ignition loss with fly ash, which indicates the content of unburned, porous carbon particles (soot), is limited to 5% by weight. The composition of fly ash is affected by the nature and origin of the coal as well as by the combustion conditions.

For example, according to DIN EN 197-1, the proportion of fly ash in CEM II Portland fly ash cement may be 6-35% by weight relative to the total weight of the Portland fly ash cement.

Silica fume (also called silica powder or microsilica) is a by-product in the production of silicon and silicon alloys in electric arc furnaces used in emission control. Silica fume typically has an ignition loss of less than 3% by weight

For example, according to DIN EN 197-1, the proportion of silica fume in CEM II Portland silica powder cement may be 6-10% by weight relative to the total weight of the Portland silica powder cement.

Rice husk ash is the result of the combustion of rice hulls which in many countries are a waste product, typically at temperatures above 700° C. The ignition loss typically is between 2-10% by weight. Rice husk ash is added to cement as pozzolan in particular in rice-producing countries.

The building material trass (ground volcanic tufa) is for example standardized under DIN 51043. Trass belongs to the volcanic glasses and consists predominantly of silicic acid, alumina as well as chemically and physically bound water.

Blast-furnace slag is a by-product of dross, coke ash and admixtures in the production of pig iron and can be processed to finely ground granulated slag and used as latent hydraulic binding agent. Blast-furnace slag, or finely ground granulated slag, generally contains soot from unburned remnants of coke ash.

For example, according to DIN EN 197-1, the proportion of finely ground granulated slag in CEM II Portland slag cement may be 6-35% by weight relative to the total weight of the Portland slag cement.

The term “soot” refers in the present document to a manifestation of carbon that forms with incomplete combustion and/or the thermal splitting off of vaporous carbon-containing substances. The soot in a hydraulically set composition is preferably a component of at least one of the further components of the hydraulically set composition mentioned above, selected from a group consisting of fly ash, silica fume, finely ground granulated slag, trass and rice husk ashes. Preferably it is therefore question of soot from fly ash, silica fume, finely ground granulated slag, trass or rice husk ash.

Typically the weight fraction of soot is 0.05-1.75% by weight, in particular 0.1-1% by weight relative to the weight of the mineral binding agent.

The preferred soot develops typically as an undesirable by-product and contains high amounts of inorganic solvents such as for example dichlormethane and toluene, extractable materials such as for example polycyclical aromatic hydrocarbons, many of which have carcinogenic properties. Furthermore, the preferred soot has a carbon content of less than 90%, typically less than 70%. The average particle size is generally 50-200 μm, in particular 70-150 μm, preferably 90-120 μm. The specific surface (BET surface according to DIN 66 131) typically is 1-20 m²/g, in particular 5-15 m²/g.

The preferred soot differs chemically and physically from industrial soot, English carbon black, which is produced by the incomplete combustion or pyrolysis of hydrocarbons.

The production of industrial soot is subject to exact processing, in particular regarding pressure and temperature, in order to produce the desired properties. Industrial soot typically has a carbon content of over 97%, a very low content of polycyclical aromatic hydrocarbons, and the particles form grape clusters. The average particle size is generally 0.02-2 μm, and the BET surface typically is 25-300 m²/g.

Industrial soot is for example used as a pigment. For use as a pigment the industrial soot can also be subjected to oxidation, affording it better wetting properties with binding agents.

The mentioned industrial soot is used in hydraulically set additives also as a pigment for inking concrete. The usual dosages of pigment are approximately 3-5% by weight relative to the cement. Because of possible problems with pigment dosage, the pigments are rarely delivered as fine powder but as an aqueous pigment preparation (slurry) or as pigment granulates which dissolve when blending the hydraulically set additive.

The additive composition Z can be present in the form of a pourable composition, for example as powder, or as a liquid composition, for example as an aqueous composition.

The additive composition Z may contain further components. Examples are solvents or additives as commonly used in concrete technology, in particular surfactant materials, stabilizers against heat and light, pigments, antifoaming agents, retardants, corrosion inhibitors or air-entraining admixtures.

Lignosulfonates are produced from lignin, which in turn is created in plants, in particular woody plants, by polymerization from three types of phenylpropanol monomers: A) 3-(4-hydroxyphenyl)-2-propen-1-ol(p-cumaryl alcohol), B) 3-(3-methoxy-4-hydroxyphenyl)-2-propen-1-ol(coniferyl alcohol), C) 3-(3,5-dimethoxy-4-hydroxyphenyl)-2-propen-1-ol(sinapyl alcohol).

The first step in building the macromolecular lignin structure is the enzymatic dehydrogenation of these monomers, whereby phenoxyl radicals are created. Random coupling reactions between these radicals lead to a three-dimensional, amorphous polymer that does not have regularly arranged or repetitive units, contrary to most other biopolymers. For this reason no definitive lignin structure can be mentioned even though various models have been suggested for an “average” structure. Since the monomers of lignin contain nine carbon atoms, the analytical data are often expressed in C9 formulas, e.g. C9H8.3O2.7(OCH3)0.97 for lignin from picea abies, and C9H8.7O2.9(OCH3)1.58 for lignin from eucalyptus regnans.

The lack of uniformity of lignin between plants of different taxa, as between the different tissues, cells and cell wall layers of each species, is well known to the person skilled in the art.

The chemical behavior of lignin is determined mainly by the presence of phenolic, benzylic and carbonylic hydroxyl groups whose frequency may vary as a function of the factors mentioned above and the isolation method.

Lignosulfonates are a by-product of cellulose production under the influence of sulfurous acid, which causes sulfonation and a certain measure of demethylation of the lignins. Like lignins, they vary greatly in structure and composition. In water they are soluble in the entire pH range while being insoluble in ethanol, acetone and other common organic solvents

Lignosulfonates are only very little surface-active. They show little tendency to reduce tension in the area between liquids and are not suitable for decreasing the surface tension of water or for forming micella. They function as dispersing agents by adsorption/desorption and by forming charges on substrates. Their surface activity may however be increased by inserting long-chain alkyl amines into the lignin structure.

Methods for isolating and purifying lignosulfonates are well-known to the person skilled in the art. In the Howard method calcium lignosulfonates are precipitated by adding a surplus of lime to spent sulfite solution. Lignosulfonates can be isolated also by forming insoluble quaternary ammonium salts with long-chain amines. At the industrial level ultrafiltration and ion-exchange chromatography can be used for purifying lignosulfonates.

Lignosulfonate series usable according to the invention are commercially available under different trade names such as e.g. Ameri-bond, Borresperse (Borregaard), Dynasperse, Kelig, Lignosol, Marasperse, Norlig (Daishowa Chemicals), Lignosite (Georgia Pacific), Reax (MEAD Westvaco), Wafolin, Wafex, Wargotan, Wanin, Wargonin (Holmens), Vanillex (Nippon Paper), Vanisperse, Vanicell, Ultrazine, Ufoxane (Borregaard), Serla Bondex, Serla-Con, Serla-Pon, Serla Sol-(Serlachius), Collex, Zewa (Wadhof-Holmes), Raylig (ITT Rayonier).

The term “lignosulfonate” refers here to a salt that is composed of lignosulfonate anions and suitable cations.

Of course, blends of different lignosulfonates may also be used, and lignosulfonates may be available also both in liquid and in solid form.

In a preferred embodiment of the invention the mineral binding agent comprises ground cement clinker, ground to cement in the presence of the additive composition Z.

It is advantageous for the additive composition Z to be added to the cement clinker before and/or during the grinding process in such a way that the proportion of lignosulfonate in the additive composition Z is 0.001-1.5% by weight, in particular between 0.005 and 0.2% by weight, preferably between 0.005 and 0.08% by weight relative to the cement clinker to be ground.

The term “cement clinkers” refers in this document to solids, typically the size of a nut, which develop when the lime-clay mixtures are heated to 1250-1500° C. and yield cement when ground.

It has been shown, among other things, that already very much smaller concentrations of lignosulfonate relative to the cement clinker can be used effectively for reducing the floating of soot in mineral binding agents, including cement clinker ground with the additive composition Z, when lignosulfonate is added as a plasticizerplasticizer-additive to mineral binding agents as known, i.e. typically 0.2-1.5% by weight relative to the weight of the mineral binding agent, or when lignosulfonate is added as a grinding agent to the cement clinker to be ground as known, i.e. typically 0.2-1.5% by weight relative to the weight of the cement clinker to be ground.

The grinding process takes place normally in a cement mill. However in principle also other mills as known in the cement industry may be used. The cement has different degrees of fineness depending on the grinding time. The fineness of cement is indicated, following Blaine, typically in cm²/g. On the other hand, the particle size distribution has also practical relevance for the fineness. Such particle size analyses are normally carried out using laser granulometry or air jet sieves.

Like other cements ground in a different way, the cement ground in this way is widely used in concrete, mortars, sealing compounds, injections or plasters.

If the additive composition Z is added to cement before and/or during the grinding of the cement clinker, a reduction in soot floating on the aqueous mineral binding agent can be seen after it is mixed with water, i.e. on the aqueous mineral binding agent, in particular on concrete. According to this embodiment, the subsequent addition of the additive composition Z is therefore no longer necessary and saves therefore a processing step for the user of the cement. Such cement is therefore a “ready-to-use” product that can be manufactured in large quantities. It was shown that the ability of the additive composition Z to reduce soot floating on a mineral binding agent, in particular an aqueous mineral binding agent, is not impaired by the grinding process.

Surprisingly it also was shown that the addition of the additive composition Z does not have a negative effect on the efficiency of the grinding process.

Surprisingly it also became evident that the effectiveness of grinding agents in the grinding process was not impaired by the addition of the additive composition Z.

A further surprise was that it is beneficial for reducing the soot floating on the aqueous mineral binding agent to add the lignosulfonate to the mineral binding agent separately from any existing grinding agents.

It is therefore also advantageous if the additive composition Z contains at least one cement grinding agent. All grinding agents known to the person skilled in the art are suitable as grinding agents. This at least one cement grinding agent is selected in particular from the group consisting of glycols, organic amines, ammonium salts of organic amines with carbonic acids and comb polymers.

The term “comb polymer” in this present document refers to a comb polymer consisting of a linear polymer chain (main chain) to which side chains are bonded via ester or ether groups. The side chains form here so to speak the “teeth” of a “comb”.

The comb polymer is preferably a comb polymer KP with side chains bonded to the main chain via ester or ether groups.

Suitable as comb polymer KP are on the one hand comb polymers with side chains bonded to the linear polymer frame via ether groups.

Side chains bonded to the linear polymer frame via ether groups can be inserted by the polymerization of vinyl ethers or allyl ethers.

Such comb polymers are for example disclosed in WO 2006/133933 A2, the content of which is herewith included specifically by reference. The vinyl ethers or allyl ethers have in particular the formula (II).

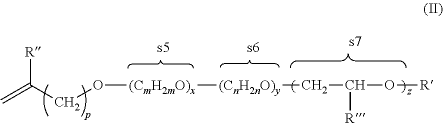

where R′ stands for H or for an aliphatic hydrocarbon radical with 1 to 20 C-atoms or a cyclo-aliphatic hydrocarbon radical with 5 to 8 C-atoms or a possibly substituted aryl radical with 6 to 14 C-atoms. R″ stands for H or for a methyl group and R″ stands for an unsubstituted or substituted aryl radical, in particular for a phenyl radical.

Also, p stand for 0 or 1; m and n independently of each other for 2, 3 or 4 respectively; and x and y and z stand, independently from each other, for values ranging from 0 to 350.

The sequence of the partial structure elements described in formula (II) as s5, s6 and s7 can be arranged in this case as alternating, block-like or at random.

In particular such comb polymers are copolymers of vinyl ether or allyl ether with maleic acid anhydride, maleic acid, and/or (meth)acrylic acid.

Suitable as comb polymer KP on the other hand are comb polymers with side chains bonded to the linear polymer frame via ester groups. This type of comb polymers KP is preferred over the comb polymers bonded to the linear polymer frame via ether groups.

Particularly preferred comb polymers KP are copolymers of the formula (I).

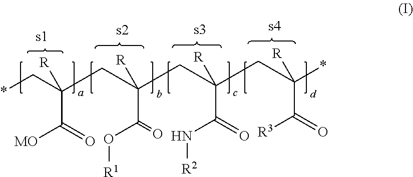

where M stand independently from each other for H⁺, alkali metal ion, alkaline earth metal ion, bi- or trivalent metal ion, ammonium ion, or organic ammonium group. The term “independently from each other” in this document means in each case that a substituent may have different available expressions in the same molecule. Thus for example the copolymer of the formula (I) may at the same time have carboxylic acid groups and sodium carboxylate groups, i.e. in this case H⁺ and Na⁺ have a different expression for M independently from each other.

The person skilled in the art understands it is question on the one hand of a carboxylate to which the ion M is bonded, and that on the other hand in case of multi-valent ions M the charge must be balanced by counterions.

Also, the substituents R stand independently from each other for hydrogen or for a methyl group.

Moreover, the substituents R¹ stand independently from each other for -[AO]_{q}—R⁴. The substituents R² stand independently from each other for a C₁ to C₂₀ alkyl group, cycloalkyl group, alkylaryl group or for -[AO]_{q}—R⁴. The substituent A stands in both cases independently from each other for a C₂ to C₄ alkyl group and R⁴ for a C₁ to C₂₀ alkyl group, cyclohexyl group or alkylaryl group, while q represents a value from 2 to 250, in particular from 8 to 200, with particular preference from 11 to 150.

Also, the substituents R³ stand independently from each other for —NH₂, —NR⁵R⁶, —OR⁷NR⁸R⁹. Here R⁵ and R⁶ stand independently from each other for a C₁ to C₂₀ alkyl group, cycloalkyl group or alkylaryl group or aryl group or for a hydroxyalkyl group or for an acetoxyethyl-(CH₃—CO—O—CH₂—CH₂—) or a hydroxyl-isopropyl-(HO—CH(CH₃)—CH₂—) or an acetoxyisopropyl group (CH₃—CO—O—CH(CH₃)—CH₂—); or R⁵ and R⁶ form together a ring of which nitrogen is a part, in order to build up a morpholine or a imidazoline ring.

The substituent R⁷ stands for a C₂-C₄ alkylene group.

Furthermore, the substituents Wand R⁹ stand, independently from each other, for a C₁ to C₂₀ alkyl group, cycloalkyl group, alkylaryl group, aryl group or for a hydroxyalkyl group.

The sequence of the partial structure elements described in formula (I) as s1, s2, s3 and s4 can be arranged in this case as alternating, block-like or at random.

Finally the indices a, b, c and d represent the molar ratios of the structural units s1, s2, s3 and s4. These structural components have the following relationship to each other

a/b/c/d=(0.1-0.9)/(0.1-0.9)/(0-0.8)/(0-0.3),

in particular a/b/c/d=(0.1-0.9)/(0.1-0.9)/(0-0.5)/(0-0.1),

preferably a/b/c/d=(0.1-0.9)/(0.1-0.9)/(0-0.3)/(0-0.06),

under the condition that a+b+c+d=1. The sum c+d is preferably larger than 0.

The production of the comb polymers KP of formula (I) may take place, on the one hand, by a radical polymerization of the respective monomers of the formula (III)ₐ, (III)_{b}, (III)_{d} and/or (III)_{d}, which then lead to the structural components (structural units) s1, s2, s3 and s4,

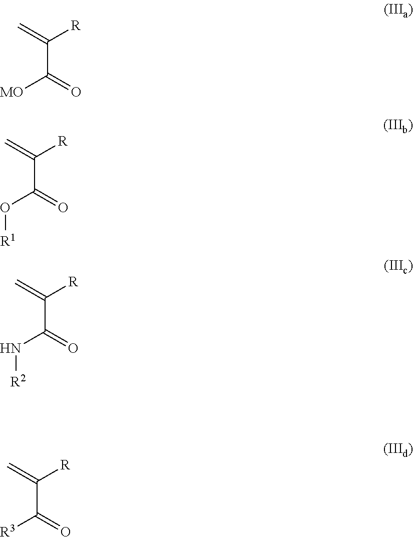

or, on the other hand, by a so-called polymer-analog transformation of a polycarboxylic acid of the formula

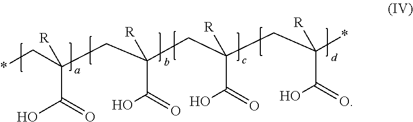

In a polymer-analog transformation the polycarboxylic acid of the formula (IV) is esterified or amidated with the respective alcohols or amines and then if necessary neutralized or partially neutralized (depending on the type of the radical M e.g. with metal hydroxides or ammonia). Details of the polymer-analog transformation are disclosed for example in EP 1 138 697 B1 on page 7 column 20 to page 8 column 50 and in the examples, or in EP 1 061 089 B1 on page 4, column 54 to page 5 column 38 as well as in the examples. In a modification thereof, as described in EP 1 348 729 A1 on page 3 to page 5 and in the examples, the comb polymer KP of formula (I) can be produced in a solid aggregate state. The disclosure of the just mentioned patents is hereby specifically included by reference.

It turned out that particularly preferred embodiments of the comb polymers KP of formula (I) are those in which c+d>0, in particular d>0. —NH—CH₂—CH₂—OH has proven particularly advantageous as radical R³.

Particularly advantageous comb polymers KP proved to be those sold commercially by Sika Schweiz AG under the trade name series ViscoCrete®.

Alkylene glycols are particularly suitable as glycols, above all of the formula OH—(CH₂—CH₂O)ᵤ—CH₂CH₂—OH, with u=0-20, in particular 0, 1, 2 or 3.

Suitable as possible glycols are also glycols selected from the list consisting of ethyl glycol, propylene glycol, polyethylene glycol, polypropylene glycol, diethylene glycol, triethylene glycol, dipropylene glycol, tripropylene glycol, reaction products of ethylene and propylene oxide, reaction products of polypropylene glycol with compounds containing active basic hydrogen (polyalcohols, polycarbonic acids, polyamines, or polyphenols), neopentyl glycol, pentandiol, butandiol and unsaturated diols, as well as their blends and derivatives.

Particularly preferred glycols are mono-, di- and polyglycols from ethylene and propylene, as well as blends thereof, because they are economical and quite water-soluble.

Alkanolamines, above all trialkanolamines are particularly suitable as organic amines, preferably triisopropanolamine (TPA) or triethanolamine (TEA) as well as blends thereof.

In a further use according to the invention, the additive composition Z, comprising at least one lignosulfonate, can be added to the mineral binding agent also after grinding the cement clinker.

This is of advantage in that the floating of soot on the mineral binding agents, in particular aqueous mineral binding agents, is reduced, even in mineral binding agents that do not comprise a cement clinker during the grinding of which to cement the additive composition Z was present.

If the additive composition Z is added to the mineral binding agent after grinding the cement clinker, it can be advantageous to increase the amount of the additive composition Z because if the additive composition Z is added before/during the grinding process of the cement clinker it is possible that the grinding process will result in a more even and finer distribution of the additive composition Z, which increases the effectiveness with regard to reducing floating soot.

Plasticizers are often added to mineral binding agents in order to reduce the need for water and/or improve processability.

The term “plasticizers” refers in this document to additives which reduce the need for water in the production of aqueous mineral binding agents and/or which ensure the processability of aqueous mineral binding agents after the addition of a certain amount of plasticizer over a longer period of time compared to aqueous mineral binding agents without added plasticizer.

Plasticizers are added to mineral binding agents typically in a proportion of 0.2-1.5% by weight relative to the weight of the mineral binding agent.

Plasticizers have however the disadvantage that the lowering of the liquid limit obtained in the process promotes the floating of soot.

In order to improve the adhesion of mineral binding agents, so-called thickeners are added which increase the viscosity of the overall system when compared to flowing agents. Examples of common thickeners are e.g. starch and cellulose derivatives like methylether (methyl starch, methyl cellulose) as well as the respective mixed ethers, which also may be hydroxypropylated and/or hydroxyethylated to various degrees (methylhydroxypropyl cellulose, methylhydroxyethyl cellulose).

However, a disadvantage of using thickeners for stabilizing a suspension is that the effectiveness goes hand in hand with noticeable changes in the rheology and consistency of the mineral binding agents, in particular with an increase of the liquid limit and the viscosity. Also, depending on the dosage there is an undesirable effect on the setting qualities of mineral binding agents which express themselves in the form of delays in solidification and hardening. Another great disadvantage is the air intake during the mixing process caused usually by the thickeners. The introduced air bubbles reduce the density of the mineral binding agents and cause thereby reduced pressure and tensile strength of the hardened material.

Surprisingly it was show that when adding the additive composition Z to an aqueous mineral binding agent composition the air intake is not increased, which is shown by determining the compressive strength, while the floating of soot is still reduced. The use of the additive composition Z is suitable therefore in particular in mineral binding agent compositions that have plasticizers.

It is also advantageous if the additive composition Z has at least one plasticizer selected from the group consisting of naphthalene sulfonic acid formaldehyde resin, melamine formaldehyde sulfite resin and comb polymers, in particular if the additive composition Z is added to the mineral binding agent after grinding the cement clinker.

Suitable and preferred comb polymers are above all those comb polymers that were mentioned above as being suitable comb polymers for grinding agents. It is of advantage if the comb polymer is a comb polymer kp with side chains bonded to the linear polymer frame via ester groups.

Preferably the proportion of lignosulfonate in the additive composition Z is 0.0025-2% by weight, in particular 0.005-0.2% by weight, with preference given to 0.005-0.1% by weight relative to the weight of the mineral binding agent (before adding the tempering water), in particular if the additive composition Z is added to the mineral binding agent after grinding the cement clinker.

If the additive composition Z is added to a mineral binding agent after grinding the cement clinker, a reduction of soot floating on the aqueous mineral binding agent can be seen after it has been mixed with water, i.e. on the aqueous mineral binding agent, in particular on concrete. Of course the additive composition Z can be added also to an aqueous mineral binding agent. The additive composition Z can be added to the mineral binding agent also mixed with the tempering water.

Surprisingly it was also found that it is beneficial for the reduction of soot floating on the aqueous mineral binding agent to add the lignosulfonate to the mineral binding agent separately from the plasticizer.

A further surprise was that the addition of the additive composition Z does not have any negative effect, for example an increase in air intake, on the pressure strength of the set mineral binding agent.

A possible additive composition Z to be added to the cement clinker before and/or during the grinding process consists of (the abbreviations of the additives are explained in detail in the example section below):
DEG, 0.005-0.02% by weight relative to the cement clinker to be ground and 5-50% by weight relative to the additive composition Z;
TEA, 0.005-0.02% by weight relative to the cement clinker to be ground and 5-50% by weight relative to the additive composition Z;
PCE, 0.005-0.02% by weight relative to the cement clinker to be ground and 5-50% by weight relative to the additive composition Z;
Ligno 1, 0.005-0.02% by weight relative to the cement clinker to be ground and 5-50% by weight relative to the additive composition Z;
Preservative, 0.1-0.4% by weight relative to the additive composition Z;
TBP, 0.1-0.4% by weight relative to the additive composition Z;

A possible additive composition Z to be added to the mineral binding agent after grinding the cement clinker consists of:
PCE, 5-94.8% by weight relative to the additive composition Z;
Ligno 1, 5-94.8% by weight relative to the additive composition Z;
Preservative, 0.1-0.4% by weight relative to the additive composition Z;
TBP, 0.1-0.4% by weight relative to the additive composition Z;

Under a further aspect the present invention relates to a method for reducing the soot floating on mineral binding agents containing the soot which comprises the step:
a) Addition of an additive composition Z comprising at least one lignosulfonate to a mineral binding agent.

Suitable and preferred soots, mineral binding agents and lignosulfonates correspond to those mentioned earlier in the document.

It is furthermore advantageous if the additive composition Z in the method mentioned above has at least one plasticizer selected from the group consisting of naphthalene sulfonic acid formaldehyde resin, melamine formaldehyde sulfite resin and comb polymers.

The additive composition Z can be added to a mineral binding agent before or after mixing with water, i.e. to the aqueous mineral binding agent. The additive composition Z can also be added to the mineral binding agent after mixing it with the tempering water.

The addition of the at least one lignosulfonate and the at least one plasticizer to the mineral binding agent at different times is advantageous in the sense that it leads to a better performance of lignosulfonate and plasticizer, in particular if the plasticizer is a comb polymer. Moreover, the addition of the at least one lignosulfonate and the at least one plasticizer to the tempering water of the mineral binding agent at different times is also advantageous in cases where the additive composition Z is added to the mineral binding agent mixed with the tempering water.

Under a further aspect the present invention relates to a method for reducing the soot floating on mineral binding agents containing the soot which comprises the step:

a′) Addition of an additive composition Z comprising at least one lignosulfonate before and/or during the grinding process of the cement clinker contained in the mineral binding agent, whereby the proportion of lignosulfonate in the additive composition Z is 0.001-1.5% by weight, in particular between 0.005 and 0.2% by weight, with preference given to between 0.005 and 0.08% by weight relative to the cement clinker to be ground. Suitable and preferred soots, mineral binding agents and lignosulfonates correspond to those mentioned earlier in the document.

It is also advantageous if the additive composition Z in the method mentioned above has at least one cement grinding agent selected in particular from the group consisting of glycols, organic amines, ammonium salts of organic amines with carboxylic acids and comb polymers, such as mentioned earlier in the document as being suitable and preferred.

The addition of the at least one lignosulfonate and the at least one cement grinding agent to the cement clinker contained in the mineral binding agent at different times is advantageous in the sense that it leads to a better performance of lignosulfonate and cement grinding agent, in particular if the cement grinding agent is a comb polymer.

### EXAMPLES

The invention is now described in more detail using examples.

Additives Used

| Name | Manufacturer |
|---|---|
| Triisopropanolamine (TIPA) | BASF SE, Germany |
| Diethylene glycol (DEG) | Hansa Chemie AG, Switzerland |
| Comb polymer with side chains bonded | Sika Schweiz AG, Switzerland |
| to the polymer frame via ester groups | |
| (PCE), | |
| Sika ViscoCrete ®-20 HE | |
| Triethanolamine (TEA) | BASF SE, Germany |
| Tributyl phosphate (TBP) | Sigma-Aldrich Chemie GmbH, |
| (antifoaming agent) | Switzerland |
| Calcium lignosulfonate (Ligno 1), | Borregaard Deutschland GmbH, |
| Borrement Ca 124 | Germany |
| Magnesium lignosulfonate (Ligno 2), | Chemische Werke Zell- |
| COLLEX 50 S5 | Wildshausen GmbH, Germany |
| Sodium lignosulfonate (Ligno 3), | Borregaard Deutschland GmbH, |
| Borrement Na 224 | Germany |

The additives V1 to V4 (comparison examples) and Z1 to Z10 (examples according to the invention) were used in the grinding process.

The additives were added to the cement clinker to be ground shortly before the grinding process in the amounts shown in Table 1.

TABLE 1

| | Name | Amount | Amount |
|---|---|---|---|
| Additive | additive | (g) | (% by weight)* |
| V1 | TIPA | 8 g | 0.04 |
| V2 | DEG | 8 g | 0.04 |
| V3 | PCE | 8 g | 0.04 |
| V4 | PCE | 4 g | 0.02 |
| | TIPA | 4 g | 0.02 |
| Z1 | Ligno 1 | 2 g | 0.01 |
| Z2 | Ligno 2 | 2 g | 0.01 |
| Z3 | Ligno 1 | 4 g | 0.02 |
| | TIPA | 4 g | 0.02 |
| Z4 | Ligno 1 | 4 g | 0.02 |
| | DEG | 4 g | 0.02 |
| Z5 | Ligno 1 | 4 g | 0.02 |
| | PCE | 4 g | 0.02 |
| Z6 | Ligno 1 | 2 g | 0.01 |
| | PCE | 4 g | 0.02 |
| | TIPA | 4 g | 0.02 |
| Z7 | Ligno 2 | 4 g | 0.02 |
| | TIPA | 4 g | 0.02 |
| Z8 | Ligno 2 | 4 g | 0.02 |
| | DEG | 4 g | 0.02 |
| Z9 | Ligno 2 | 4 g | 0.02 |
| | PCE | 4 g | 0.02 |
| Z10 | Ligno 2 | 2 g | 0.01 |
| | PCE | 4 g | 0.02 |
| | TIPA | 4 g | 0.02 |

*Amount in % by weight refers to the cement clinker to be ground

### Cement Clinker Used

The cement clinkers used consisted of 63% C3S, 8% C2S, 11% C3A and 8% C4AF.

### Grinding of the Cement Clinker

20 kg of a mixture of the respective cement clinker and one of the respective additives, and/or without additives, were blended in the dosage indicated above and ground for approx. 100 minutes in a drum ball mill manufactured by Siebtechnik at a temperature of 100° C. and rotating at a speed of 40 revolutions per minute.

### Testing Methods

Grinding time₄₅₀₀: The time until the mixture had a Blaine fineness of 4500 cm²/g under DIN EN 196-6 after being ground in the ball mill was measured.

Fineness: The fineness was measured according to Blaine using a Blaine machine manufactured by Wasag Chemie.

### Evaluation of the Grinding Efficiency

(+), Grinding time until reaching a Blaine fineness of 4500 cm²/g

≦90% of the grinding time until reaching a Blaine fineness of 4500 cm²/g without additives (B1)

(+/−), Grinding time until reaching a Blaine fineness of 4500 cm²/g

≦95% of the grinding time until reaching a Blaine fineness of 4500 cm²/g without additives (B1)

(−), Grinding time until reaching a Blaine fineness of 4500 cm²/g

≦100% of the grinding time until reaching a Blaine fineness of 4500 cm²/g without additives (B1)

The results are shown in Table 2.

Furthermore, the soot floating on mortar containing cement ground in this way was measured.

| Composition of the mortar mixture: | |
|---|---|
| Standard mortar under EN 196-1 | Amount in g |
| Cement obtained in the above-mentioned | 450 |
| grinding tests (containing 4% fly ash) | |
| Tap water | 225 |
| Standard sand 0-4 mm | 1350 |

The cement used was the cement obtained in the above-mentioned grinding tests. It had a fineness after Blaine of approx. 4500 cm²/g

The mortar was produced under EN 196-1, poured into forms and compacted.

After compaction (under EN 196-1 on a vibration table) the floating black particles (soot) were evaluated by sight.

No particles visible=(+)

Few particles visible=(+/−)

Particles clearly visible=(−)

The results are shown in Table 2.

TABLE 2

| | Additive | Grinding | Floating |
|---|---|---|---|
| No. | (% by weight) | efficiency | soot |
| B1 | no additive | (−) | (−) |
| B2 | V1 (TIPA) | (+) | (−) |
| B3 | V2 (DEG) | (+) | (−) |
| B4 | V3 (PCE) | (+) | (−) |
| B5 | V4 (PCE)/ | (+) | (−) |
| | (TIPA) | | |
| B6 | Z1 (Ligno1) | (+/−) | (+) |
| B7 | Z2 (Ligno2) | (+/−) | (+) |
| B8 | Z3 | (+) | (+/−) |
| | (Ligno1)/TIPA | | |
| B9 | Z4 | (+) | (+) |
| | (Ligno1)/DEG | | |
| B10 | Z5 | (+) | (+) |
| | (Ligno1)/PCE | | |
| B11 | Z6 | (+) | (+/−) |
| | (Ligno1)/PCE/ | | |
| | TIPA | | |
| B12 | Z7 | (+) | (+/−) |
| | (Ligno2)/TIPA | | |
| B13 | Z8 | (+) | (+) |
| | (Ligno2)/DEG | | |
| B14 | Z9 | (+) | (+) |
| | (Ligno2)/PCE | | |
| B15 | Z10 | (+) | (+/−) |
| | (Ligno2)/PCE/ | | |
| | TIPA | | |

In order to further determine the effectiveness of the additives Z11 to Z14 (examples according to the invention), the mortar blends were reacted with the various additives (see Table 3).

TABLE 3

| | | Amount |
|---|---|---|
| Additive | Name additive | (% by weight)* |
| Z11 | Ligno 1 | 0.05 |
| Z12 | Ligno 2 | 0.05 |
| Z13 | Ligno 3 | 0.05 |
| Z14 | Ligno 2 | 0.017 |
| | DEG | 0.017 |
| | PCE | 0.017 |

*Amount in % by weight refers to the mortar mixture before adding water

The mortar blend was manufactured with CEM II A-LL 42.5 with 5% fly ash. The fineness of the mortar blend after Blaine (EN 196-6) was approx. 4500 cm²/g. The various additives of Table 3 were added to the mortar blends together with the tempering water. The blending followed EN 196-1. The indicated amounts in % by weight refer to the mineral binding agent before adding the tempering water, in this case to the mortar blend before adding water.

The compressive strength as well as the floating soot of the mortar blends obtained in this way were measured (see Table 4).

The test for determining the compressive strength (in N/mm²) using prisms (40×40×160 mm) after 1 day, 2 days, 7 days and 28 days followed

EN 196-1.

In order to measure the floating of soot, the mortar was poured into forms and compacted (following EN 196-1 under a vibration table), and after compaction the floating black particles (soot) were evaluated by sight.

No particles visible=(++)

Few particles visible=(+)

Particles clearly visible=(−)

TABLE 4
Compressive strengths in N/mm² after 1, 2, 7 and
28 days (d) and floating of black particles (soot).

| | | Compressive strength | | | | |
|---|---|---|---|---|---|---|
| | | | | | After | |
| No. | Additive | After 1 d | After 2 d | After 7 d | 28 d | Floating |
| B16 | no | 12.2 | 24.4 | 34.6 | 41.7 | (−) |
| | additive | | | | | |
| B17 | Z11 | 11.6 | 24.7 | 33.5 | 41.0 | (++) |
| B18 | Z12 | 11.2 | 24.4 | 33.2 | 41.4 | (++) |
| B19 | Z13 | 11.2 | 24.9 | 33.3 | 41.2 | (++) |
| B20 | Z14 | n/a | n/a | n/a | n/a | (+) |

1. A method for reducing soot floating on mineral binding agents containing said soot, the method comprising:
mixing an additive composition Z comprising at least one lignosulfonate for reducing the soot floating on the mineral binding agents containing said soot, wherein the mineral binding agents are hydraulic binding agents and/or latent hydraulic and/or pozzolanic binding agents selected from the group consisting of cement, fly ashes, silica fume, trass, rice husk ash, finely ground granulated slag, and blends thereof.

2. The method according to claim 1, wherein a weight fraction of the soot is 0.05-1.75% by weight relative to a weight of the mineral binding agent.

3. The method according to claim 1, wherein the soot has an average particle size of 50-200 μm and/or a specific surface, BET according to DIN 66 131, from 1-20 m²/g.

4. The method according to claim 1, wherein the mineral binding agent comprises ground cement clinker, ground into cement in the presence of the additive composition Z.

5. The method according to claim 4, wherein the additive composition Z is added to the cement clinker before and/or during the grinding process in such a way that the proportion of lignosulfonate in the additive composition Z is 0.001-1.5% by weight relative to the cement clinker to be ground.

6. The method according to claim 1, wherein the additive composition Z has at least one cement grinding agent selected from the group consisting of glycols, organic amines, ammonium salts of organic amines with carboxylic acids and comb polymers.

7. The method according to claim 1, wherein the additive composition Z has at least one plasticizer selected from the group consisting of naphthalene sulfonic acid formaldehyde resin, melamine formaldehyde sulfite resin and comb polymers.

8. The method according to claim 7, wherein the comb polymer is a comb polymer KP with side chains bonded to the linear polymer frame via ester groups.

9. The method according to claim 7, wherein a proportion of lignosulfonate in the additive composition Z is 0.0025-2% by weight relative to a weight of the mineral binding agent.

10. Method for reducing the amount of soot floating on the mineral binding agents containing said soot, comprising:
adding an additive composition Z comprising at least one lignosulfonate to a mineral binding agent.

11. Method according to claim 10, wherein the additive composition Z has at least one plasticizer selected from the group consisting of naphthalene sulfonic acid formaldehyde resin, melamine formaldehyde sulfite resin and comb polymers.

12. Method according to claim 11, wherein the at least one lignosulfonate is added to the mineral binding agent at a different time than the at least one plasticizer.

13. Method for reducing the amount of soot floating on mineral binding agents containing said soot, comprising:
adding an additive composition Z comprising at least one lignosulfonate before and/or during the grinding process of cement clinker contained in the mineral binding agent, wherein a proportion of lignosulfonate in the additive composition Z is 0.001-1.5% by weight relative to the cement clinker to be ground.

14. Method according to claim 13, wherein the additive composition Z has at least one cement grinding agent selected from the group consisting of glycols, organic amines, ammonium salts of organic amines with carboxylic acids and comb polymers.

15. Method according to claim 14, wherein the at least one lignosulfonate is added to the cement clinker at a different time than the at least one cement grinding agent contained in the mineral binding agent.
